(19) United States
(12) Patent Application Publication
(10) Pub. No.: US 2018/0311879 A1
(43) Pub. Date: Nov. 1, 2018

(54) PLASTIC INJECTION-MOULDING MACHINE HAVING AT LEAST ONE CAMERA

(71) Applicant: KraussMaffei Technologies GmbH, 80997 München (DE)

(72) Inventor: GÜNTHER GRIMM, Hilgertshausen (DE)

(73) Assignee: KraussMaffei Technologies GmbH, 80997 München (DE)

(21) Appl. No.: 15/769,692

(22) PCT Filed: Aug. 5, 2016
(86) PCT No.: PCT/EP2016/068808

§ 371 Date: Apr. 19, 2018

(30) Foreign Application Priority Data
Oct. 30, 2015 (DE) 10 2015 118 571.7

(51) Int. Cl. B29C 45/76; B29C 45/17; G05B 19/4155

(52) U.S. Cl. CPC B29C 45/762; B29C 45/766; B29C 45/1774; G05B 2219/45204; B29C 2045/7606; B29C 2945/76464; B29C 2945/76939; G05B 19/4155

(57) ABSTRACT

A plastic injection-moulding machine includes an injection unit for processing a plastic mass to be moulded, and a closing unit having an injection-moulding tool having at least one cavity, into which the plastic mass processed by the injection unit is injected to produce a moulded part. A machine controller controls the injection unit and the closing unit, and a user interface device, which has at least one input means and at least one output means. The at least one output means is designed as a screen. At least one camera is provided to record a region of the plastic injection-moulding machine lying behind the user interface device, with the machine controller being designed to display the region recorded by the camera on the screen.

The invention relates to a plastic injection-moulding machine, comprising an injection unit for processing a plastic mass to be moulded, a closing unit having an injection-moulding tool, which has at least one cavity, into which the plastic mass processed by the injection unit is injected in order to produce a moulded part, and comprising a machine controller, which is designed to control the injection unit and the closing unit, and a user interface device, which has at least one input means and at least one output means, which is designed as a screen, and comprising furthermore at least one camera, which is designed for monitoring an environment of the plastic injection-moulding machine.

From WO 2007/028721 A1 an injection-moulding installation is known, having an injection-moulding machine comprising an injection unit and a closing unit with injection-moulding tools for the production of moulded parts, and a screen, and with a working space comprising the injection-moulding machine itself and, if applicable, auxiliary equipment, in which one or more cameras are provided for monitoring the working space, wherein the images of the various cameras are able to be presented on the screen selectively in succession and/or simultaneously.

The company publication of Wittmann Battenfield GmbH, TM 180-500 t Series, 09/2013 shows a plastic injection-moulding machine which has a webcam, i.e. a network camera, in order to be able to view regions which are not normally able to be viewed, such as of a robot deposit station or of a tool region.

DE 20 2005 013 954 U1 (D2) discloses that two cameras can be provided at an injection-moulding installation and namely in the upper corners of working spaces.

DE 10 2013 012 914 discloses that cameras can enable a supervision and namely in order to be able to see particular aspects of the operation of a system remotely on a display of the control device.

WO 2015/031989 A1 describes a user interface device of a plastic injection-moulding machine, which can be configured as a smartphone.

It is an object of the invention to provide a plastic injection-moulding machine which is designed so as to be particularly clear for a machine operator.

The problem is solved by a plastic injection-moulding machine, comprising an injection unit for processing a plastic mass to be moulded, a closing unit having an injection-moulding tool, which has at least one cavity, into which the plastic mass processed by the injection unit is injected in order to produce a moulded part, and comprising a machine controller, which is designed to control the injection unit and the closing unit, and a user interface device, which has at least one input means and at least one output means, which is designed as a screen, and comprising furthermore at least one camera, which is designed for monitoring an environment of the plastic injection-moulding machine, wherein the machine controller is designed to display on the screen the region recorded by the camera, and wherein the camera is designed to record a region of the plastic injection-moulding machine lying behind the user interface device, and the user interface device has a housing which comprises a front side and a rear side, wherein the screen is arranged on the front side and the camera is arranged on the rear side.

A plastic injection-moulding machine generally comprises at least one injection unit for processing a plastic mass which is to be moulded, an injection nozzle arranged at the front end of the injection unit, which injection nozzle is able to be coupled to an injection-moulding tool, the injection-moulding tool and a closing unit, which is usually arranged on a machine frame of the plastic injection-moulding unit, and has a fixed platen and a movable platen. The injection-moulding tool comprises at least two mould halves, the one mould half of which is secured on the fixed platen and the other mould half of which is secured on the movable platen, such that with an opening of the closing unit, i.e. with a moving apart of the fixed platen and movable platen, the at least one cavity of the injection-moulding tool is freed. The injection unit can have one or more extruders which are respectively designed to melt, mix and homogenize, if applicable to degas, at least one plastic pre-product, such as for example a plastic granulate. Each extruder can have, in addition, a charging hopper for the feeding of, for example, a plastic granulate.

The plastic injection-moulding machine has a plurality of machine parts. Certain machine parts can be mounted movably and can be moved automatically by means of a motor or drive, in particular a hydraulic or electric motor or respectively a hydraulic or electric drive, or in a manually controlled manner in a manual driving operation. Thus, the closing unit represents an exemplary machine part which can be opened or closed, controlled by the machine controller of the plastic injection-moulding machine, in accordance with a machine program running in the machine controller, automatically or in a manually controlled manner in a manual driving operation, for example by means of the user interface device. The injection unit represents another exemplary machine part which can be operated, controlled by the machine controller of the plastic injection-moulding machine, in accordance with a machine program running in the machine controller, automatically or in a manually controlled manner in a manual driving operation, for example by means of the user interface device, for example by controlling or regulating the rotation speed of a screw conveyor of the injection unit or by controlling or regulating at least one heating device of the injection unit.

The user interface device has at least one input means and at least one output means. At least one output means is configured as a screen. Apart from a small number of safety-relevant electromechanical input means, such as for example an emergency stop switch, the user interface device can be formed substantially solely by a single screen. The screen can be configured as a touchscreen and in this respect can have both output means and also input means. The user interface device can have a housing which comprises a front side and a rear side, wherein the screen is arranged on the front side. The housing, or respectively at least the rear side thereof, is constructed so as to be optically opaque, which means that at least the rear side of the housing is not embodied so as to be transparent. Usually, the housing of the user interface device is produced from metal or plastic.

The plastic injection-moulding machine has, in addition, at least one camera. The at least one camera is designed for monitoring an environment of the plastic injection-moulding machine. A monitoring of an environment of the plastic injection-moulding machine can be understood to mean that the at least one camera can visually record the plastic injection-moulding machine from the exterior at least partially or completely. Provision can also be made that the at least one camera can visually record spaces within the plastic injection-moulding machine. Thus, provision can be made that the at least one camera can visually record the region of the closing unit and/or the space between two opened tool halves. The at least one camera can, for example, also visually record the region of the injection unit.

By the camera being designed to record a region of the plastic injection-moulding machine lying behind the user interface device, and by the machine controller being designed to display on the screen the region recorded by the camera, a plastic injection-moulding machine is created, which is designed so as to be particularly clear for a machine operator, because thus regions of the plastic injection-moulding machine can be viewed by a machine operator which would otherwise be visually concealed by the user interface device. It is then unnecessary for a machine operator to have to manually mechanically move the user interface device out from a sight line in order to be able to free and then view the region of the plastic injection-moulding machine originally lying behind the user interface device.

This circumstance is of increasing importance because the user interface devices are becoming continually larger with regard to development technology, i.e. the area of the screen of the user interface device is become increasingly larger. On the one hand, this leads to an increasingly large area of the plastic injection-moulding machine being visually concealed for a machine operator by the increasingly larger user interface devices. On the other hand, owing to the increasing size of the screens, the weight of the entire user interface device also increases, so that increasing application of force is entailed to move the user interface device manually out from a desired field of view.

By the camera being designed to record a region of the plastic injection-moulding machine lying behind the user interface device and by the machine controller being designed to display on the screen the region recorded by the camera, a machine operator can view on the screen the region of the plastic injection-moulding machine lying, for him, visually behind the user interface device.

The user interface device has a housing which comprises a front side and a rear side, wherein the screen is arranged on the front side and the camera is arranged on the rear side.

The front side of the housing can be formed by a closed-surfaced front wall of the housing, wherein the screen can be placed onto the closed-surfaced front wall. Alternatively, the front side of the housing can be formed only by a frame surrounding and/or enclosing the screen. The rear side of the housing can be formed by a closed-surfaced rear wall of the housing. The closed-surfaced rear wall of the housing can in this respect cover the rear side of the screen. The camera arranged on the rear side can accordingly be arranged in a first embodiment externally on the closed-surfaced rear wall of the housing. In a second embodiment, the otherwise closed-surfaced rear wall can have a cutout, such as for example a window or a hole, and the camera can be arranged at least partially or completely in the interior of the housing, wherein the optical beam path of the camera leads via the cutout, the window or the hole of the rear wall.

By the camera being arranged directly on the rear side of the housing of the user interface device, precisely always the region of the environment lying precisely behind the user interface device is recorded optically by the camera. Therefore, complex movement devices can be dispensed with, which would otherwise be necessary for example for pivoting cameras which are arranged elsewhere, in order to be able to optically record by the camera the respectively correct region of the environment. Depending on the whereabouts of the machine operator and his position or respectively depending on his viewing direction relative to the user interface device, namely a different region of the plastic injection-moulding machine can be concealed by the user interface device. When the camera is arranged directly on the rear side of the housing of the user interface device, the camera is, as it were, automatically moved and/or pivoted in the same manner as the user interface device itself is moved and/or pivoted. In this case, the camera moves synchronously to the same extent as the user interface device itself. The user interface device can in this respect be held by means of an adjusting device in various positions and/or locations in the room. The adjusting device can be designed for manual adjusting. Alternatively, the adjusting device can be designed for automatic adjusting, i.e. driven in a controlled manner.

The plastic injection-moulding machine can accordingly have an adjusting device which carries the user interface device and which is designed to hold the user interface device in different positions and/or locations in the space, wherein the camera is secured on the rear side of the housing of the user interface device such that, on an adjusting of the adjusting device, the camera also takes up the position and/or location in the space corresponding to the user interface device.

The camera can be rigidly secured on the rear side of the housing or respectively with respect to the rear side of the housing of the user interface device.

Alternatively or additionally to the first embodiment variant, in another embodiment variant, or respectively an embodiment variant building thereon, the camera or at least a supplementary camera can be arranged at a location of the plastic injection-moulding machine separate from the user interface device, in particular accordingly several cameras can be arranged at various locations of the plastic injection-moulding machine separate form the user interface device, and the at least one camera can then be connected to an evaluating device, which is designed to store image information captured by the camera, to record the instantaneous position and location of the user interface device, and to alter the stored image information as a function of the recorded instantaneous position and location of the user interface device, and to have it displayed on the screen, such that in every position and/or location of the user interface device the region of the plastic injection-moulding machine is displayed on the screen which lies behind the user interface device, i.e. which lies behind the user interface device in the viewing direction of an observer or respectively of the machine operator onto the screen.

By the at least one camera being arranged at a location of the plastic injection-moulding machine separate from the user interface device, cameras for example already present at the plastic injection-moulding machine for other purposes can be used for the purpose according to the invention, without it being necessary to provide on the user interface device a camera designed specifically for the purpose according to the invention.

In an exemplary variant, provision can be made that the camera is in fact arranged behind the user interface device, but is not installed directly in the housing of the user interface device. Thus, the plastic injection-moulding machine can be provided for example completely with a casing, such as a housing enclosing the working space of the plastic injection-moulding machine in a closed position and freeing it in an open position, or with a protective door, in particular without inspection panes. On an outer wall of such a casing, in particular sheet metal casing or respectively housing or protective door, the user interface device can be mounted securely or adjustably. In this variant, a camera is not mounted directly behind the housing of the user interface device, but rather is only arranged indirectly behind the user interface device and namely within the casing or respectively housing or protective door. Via an adjustment mechanism coupled to the user interface device or via an electromotive adjusting device, the camera can take part here in the same movements as the user interface device, e.g. in the case of a lateral displacement of the casing or respectively of the housing or of the protective door, so that the optical impression arises that a machine operator would have by means of the user interface device a type of X-ray device, by which he could see through the casing or respectively housing or protective door and namely precisely the section which is actually concealed visually by the user interface device.

By the at least one camera being arranged at a location of the plastic injection-moulding machine separate from the user interface device, improved visual presentations can also be produced on the screen, for example in that the image information presented in an altered manner on the screen on the basis of the image information captured by the camera are presented in an altered manner not only depending on the position and location of the user interface device itself, but also depending on the whereabouts of the machine operator and his position or respectively are presented in an altered manner according to his viewing direction relative to the user interface device. Thus, for example, with the presentation on the screen, it can be taken into account that the machine operator is not looking perpendicularly onto the screen, but rather is looking onto the screen at an acute angle from the side, and accordingly then precisely the region of the plastic injection-moulding machine lying perpendicularly behind the user interface device is not presented on the screen, but rather a slightly different region. For this, if applicable also the position or respectively the viewing direction of the machine operator can also be recorded automatically, for example by generally known sensors or tracking devices, and evaluated by the machine controller, and taken into consideration accordingly in the displaying of the presentation on the screen.

The evaluating device is therefore part of the plastic injection-moulding machine or respectively the evaluating device can be part of the machine controller, alternatively the evaluating device can be an evaluating device separate from the machine controller, which is in communicative connection with the machine controller. The evaluating device can be designed in a manner known per se to the specialist in the art with regard to the individual aspects of storing the image information recorded by the camera, recording the instantaneous position and location of the user interface device and of the basic altering and presenting of image information and in particular can comprise methods known from the technical field of augmented reality and/or known devices such as for example generally known tracking systems. According to the invention, however, provision is made that the evaluating device is additionally designed such that in every position and/or location of the user interface device, the region of the environment of the plastic injection-moulding machine which lies behind the user interface device is displayed on the screen, i.e. which lies behind the user interface device in the viewing direction of an observer or respectively of the machine operator onto the screen.

The user interface device can be connected to the machine controller, and the at least one input means of the user interface device can be designed here, with its manual actuation, to fade out an operating surface of the machine controller displayed on the screen and to fade in on the screen the region of the environment of the plastic injection-moulding machine lying behind the user interface device. By the input means being designed, with its manual actuation, to fade out an operating surface of the machine controller displayed on the screen and to fade in on the screen the region of the environment of the plastic injection-moulding machine lying behind the user interface device, a machine operator for example no longer has to pivot the user interface device manually to the side, in order to be able to view a region of the plastic injection-moulding machine lying therebehind, but rather he can maintain his position and leave the user interface device in its hitherto position and/or location and nevertheless, as it were at the push of a button, view the region lying in a visually concealed manner behind the user interface device, and namely as a presentation on the screen. On a renewed manual actuation of the input means, provision can be made that the presented region of the environment of the plastic injection-moulding machine lying behind the user interface device is faded out again from the screen, and the actual operating surface of the machine controller is displayed on the screen again.

The user interface device can be connected to the machine controller and the at least one input means of the user interface device can be designed here, with its manual actuation, to display an operating surface of the machine controller displayed on the screen and the region of the environment of the plastic injection-moulding machine lying behind the user interface device on the screen in a superimposed presentation simultaneously. A simultaneous superimposed presentation is provided for example when the displayed operating surface of the machine controller is displayed in a slightly transparent, semi-transparent manner or respectively reduced in contrast, and at the same time also the presentation of the region of the environment of the plastic injection-moulding machine lying behind the user interface device can be seen on the screen. In such a slightly transparent or respectively semi-transparent superimposed presentation, provision can be made that any other input means of the operating surface which may be present are deactivated, i.e. an actuating for example of the slightly transparent or respectively semi-transparent touch input means does not lead to a corresponding reaction by the machine controller. Alternatively, in such a slightly transparent or respectively semi-transparent superimposed presentation, provision can be made that any other input means of the operating surface which may be present continue to remain activated, i.e. an actuating for example of the slightly transparent or respectively semi-transparent touch input means leads to a corresponding reaction by the machine controller.

In all corresponding embodiments, the input means or respectively any input means of the user interface device can be a touch input means of the screen, or the screen can have a touch surface designed for the detection of gestures.

The user interface device can have at least one touch input means, which with regard to its position and/or location is designed on the screen such that it is superimposed to a presentation of a machine part of the plastic injection-moulding machine recorded by means of the camera and displayed on the screen.

The machine controller can be designed, furthermore, on the basis of a manual actuation of the touch input means, to control in a predetermined manner the machine part of the plastic injection-moulding machine which is superimposed by the touch input means.

Thus, for example, provision can be made that a corresponding touch input means is virtually cross-faded to a movable platen of the closing unit, faded in on the screen, which input means has for example the contour of the faded in movable platen, wherein with a manual touching of the screen region, which is surrounded by the contour of the faded in movable platen, the machine controller is instructed to open or to close the movable platen accordingly.

Various exemplary example embodiments of the invention are explained in further detail in the following figure description with reference to the enclosed diagrammatic figures. Concrete features of these example embodiments, irrespective of in which concrete context they are mentioned, can represent general features of the invention, if applicable also regarded individually or in other combinations.

There are shown:

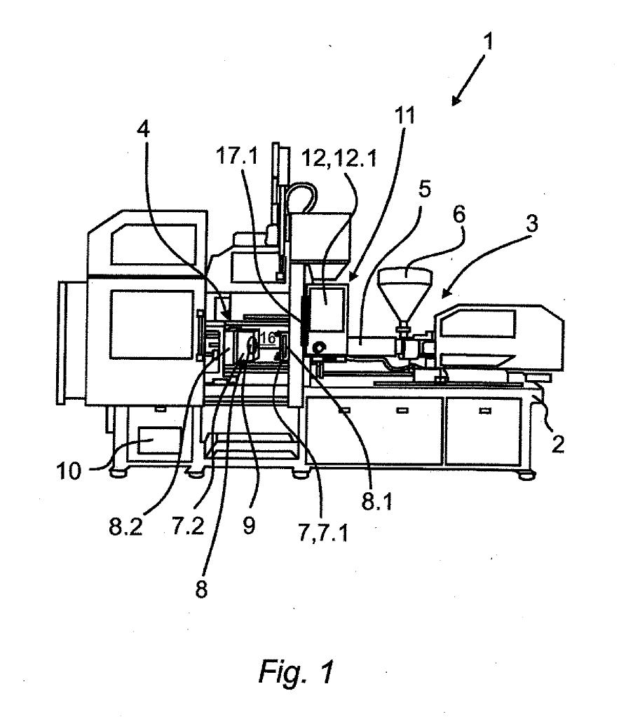

FIG. 1 a diagrammatic illustration of an exemplary first embodiment variant of a plastic injection-moulding machine with a user interface device,

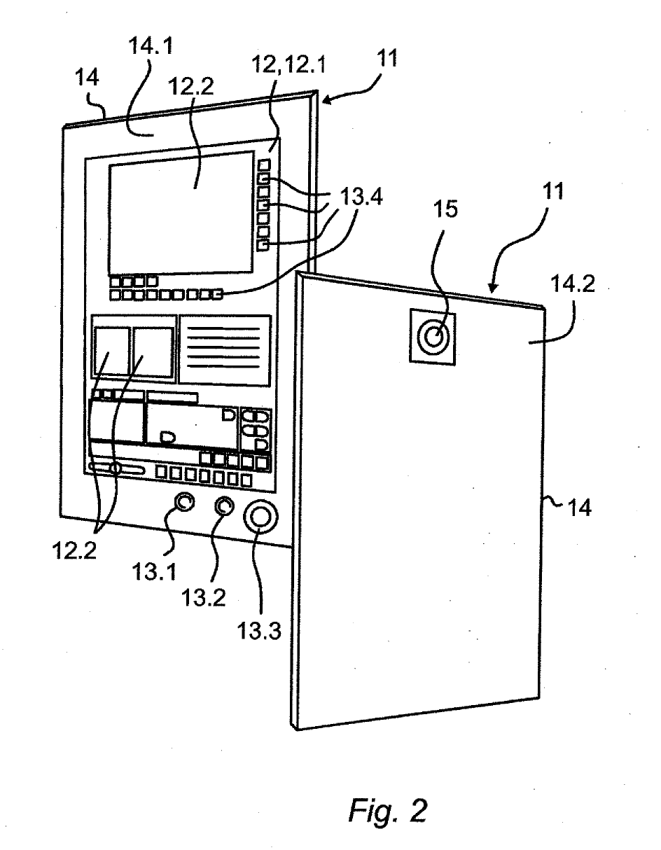

FIG. 2 a diagrammatic illustration of an exemplary embodiment variant of a user interface device according to the invention with a camera in a front view and in a rear view, and

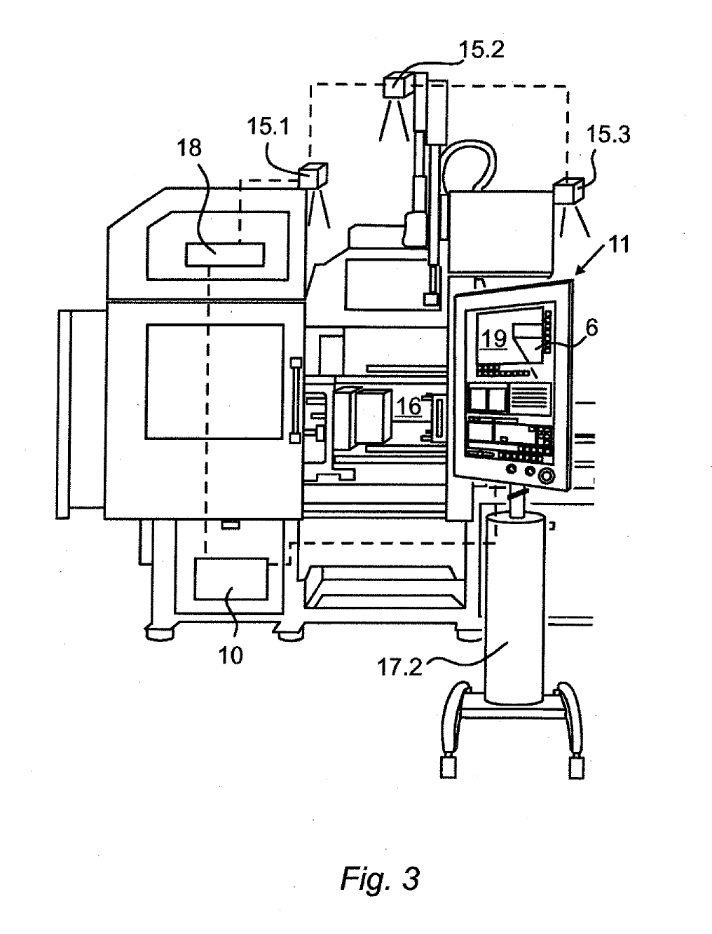

FIG. 3 a diagrammatic illustration of an exemplary second embodiment variant of a plastic injection-moulding machine with an adjustable user interface device.

The exemplary plastic injection-moulding machine 1 shown in FIG. 1 has a machine frame 2, on which an injection unit 3 and a closing unit 4 are arranged.

The injection unit 3 serves for the processing of a plastic mass which is to be moulded. In the case of the present example embodiment, the injection unit 3 has an extruder 5. The extruder 5 is designed to melt, mix and homogenize, if applicable to degas, at least one plastic pre-product, such as for example a plastic granulate. For this, or respectively for the feeding of, for example, the plastic granulate, the extruder 5 has a charging hopper 6.

At a front end of the injection unit 3 or respectively at a front end of the extruder 5, an injection nozzle is arranged, which is not illustrated in further detail, which is coupled to an injection-moulding tool 7. The injection-moulding tool 7 is arranged in a closing unit 8 of the plastic injection-moulding machine 1, which is usually arranged on the machine frame 2 of the plastic injection-moulding machine 1 and has a fixed platen 8.1 and a movable platen 8.2. The injection-moulding tool 7 comprises at least two mould halves 7.1 and 7.2, of which the one mould half 7.1 is secured on the fixed platen 8.1 and the other mould half 7.2 is secured on the movable platen 8.2, such that with an opening of the closing unit 8, i.e. with a moving apart of the fixed platen 8.1 and movable platen 8.2, at least one cavity 9 of the injection-moulding tool 7 is freed.

The plastic injection-moulding machine 1 has, accordingly, a plurality of machine parts. Certain machine parts can be movably mounted and can be moved by means of a motor or a drive, in particular a hydraulic or electric motor or respectively a hydraulic or electric drive, automatically, or in a manually controlled manner in a manual driving operation. Thus, the closing unit 4 represents an exemplary machine part which, controlled by a machine controller 10 of the plastic injection-moulding machine 1, in accordance with a machine program running in the machine controller 10, can be opened or closed automatically or in a manually controlled manner in a manual driving operation for example by means of a user interface device 11 of the plastic injection-moulding machine 1. The injection unit 3 represents another exemplary machine part which, controlled by the machine controller 10 of the plastic injection-moulding machine 1, in accordance with a machine program running in the machine controller 10, can be operated automatically or in a manually controlled manner in a manual driving operation for example by means of the user interface device 11, for example by controlling or regulating the rotation speed of the extruder 5 or by controlling or regulating at least one heating device, not illustrated in further detail, of the injection unit 3.

FIG. 2 shows an exemplary embodiment of a user interface device 11 and namely illustrated on the left in a front view, and illustrated on the right in a rear view. As is illustrated in particular in FIG. 2, the user interface device 11, in the case of the present example embodiment, has a plurality of input means 13.1, 13.2, 13.3 and an output means 12 in the form of a screen 12,1. In the case of the present example embodiment, the screen 12,1 is configured as a touchscreen. Apart from a small number of safety-relevant electromechanical input means, such as for example the third input means 13.3 in the form of an emergency stop switch, the user interface device 11 can be formed substantially solely by a single screen 12.1. In the embodiment as a touchscreen, the screen 12.1 can in this respect have both screen output means 12.2 and also screen input means 13.4. The user interface device 11 has a housing 14, which comprises a front side 14.1 and a rear side 14.2, wherein the screen 12.1 is arranged on the front side 14.1. The housing 14 or respectively at least its rear side 14.2 is designed to be optically opaque, which means that at least the rear side 14.2 of the housing 14 is not embodied so as to be transparent. Usually, the housing 14 of the user interface device 11 is made from metal or plastic.

The plastic injection-moulding machine 1 has in addition, according to the invention, at least one camera 15. The at least one camera 15 is designed for monitoring an environment of the plastic injection-moulding machine 1. A monitoring of an environment of the plastic injection-moulding machine 1 can be understood to mean that the at least one camera 15 can visually record the plastic injection-moulding machine 1 from the exterior at least partially or completely. Provision can also be made that the at least one camera 15 can visually record spaces 16 within the plastic injection-moulding machine 1. Thus, provision can be made that the at least one camera 15 can visually record the region of the closing unit 8 and/or the space between the two opened mould halves 7.1, 7.2. The at least one camera 15 can, for example, also visually record the region of the injection unit 3, as indicated in FIG. 3.

The plastic injection-moulding machine 1 therefore has an injection unit 3 for processing a plastic mass which is to be moulded, a closing unit 8 with an injection-moulding tool 7, which has at least one cavity 9, into which the plastic mass processed by the injection unit 3 is injected, in order to produce a moulded part. In addition, the plastic injection-moulding machine 1 has a machine controller 10, which is designed to control at least the injection unit 3 and the closing unit 8. Furthermore, the plastic injection-moulding machine 1 has a user interface device 11, which has at least one input means 13.1-13.3 and at least one output means 12, which is configured as a screen 12.1. At least one camera 15 is designed for monitoring an environment of the plastic injection-moulding machine 1, wherein the camera 15 according to the invention is designed, in addition, to display on the screen 12.1 a region of the environment of the plastic injection-moulding machine 1 lying behind the user interface device 11.

The plastic injection-moulding machine 1 has an adjusting device 17, which carries the user interface device 11 and which is designed to hold the user interface device 11 in different positions and/or locations in the space, wherein the camera 15 is secured to the rear side of the housing 14 of the user interface device 11 such that the camera 15 also takes up a position and/or location in the space corresponding to that of the user interface device 11 on an adjusting of the adjusting device 17.

In the case of the first example embodiment of a plastic injection-moulding machine 1 according to FIG. 1, the adjusting device 17 is formed by a hinge-like pivoting device 17.1, which mounts the user interface device 11 pivotably about a vertical axis on the plastic injection-moulding machine 1, in particular on a part of its machine frame 2.

In the case of the second example embodiment of a plastic injection-moulding machine 1 according to FIG. 3, the adjusting device 17 is formed by a mobile stand 17.2, which carries the user interface device 11, in order to be able to move the user interface device 11 on a floor independently of the plastic injection-moulding machine 1.

In a further example embodiment, which is not illustrated, the user interface device 11 can, however, also be secured rigidly on the plastic injection-moulding machine 1, in particular on a part of its machine frame 2. Thus, a complex adjusting device 17 can be dispensed with, because owing to the camera 15 according to the invention it is no longer obligatorily necessary to be able to move the user interface device 11 relative to the plastic injection-moulding machine 1, in order to be able to view a region of the plastic injection-moulding machine 1 lying therebehind, because the region of the plastic injection-moulding machine 1 lying behind the user interface device 11 can be displayed on the screen 12.1 as needed.

In the illustrated embodiment variants, the camera 15 is rigidly secured on the rear side 14.2 of the housing 14 of the user interface device 11.

The camera 15 or at least one further camera 15.1, 15.2, 15.3 can, however, also be arranged at a location of the plastic injection-moulding machine 1 separate form the user interface device 11, in particular a plurality of cameras 15.1, 15.2, 15.3 can be arranged at various locations of the plastic injection-moulding machine 1 separate from the user interface device 11, as is indicated in FIG. 3.

In such an embodiment, the cameras 15.1, 15.2, 15.3 can be connected to an evaluating device 18, which is designed to store image information captured by the cameras 15.1, 15.2, 15.3, to record the instantaneous position and location of the user interface device 11, and to alter and display on the screen 12.1 the stored image information in accordance with the recorded instantaneous position and location of the user interface device 11, such that in each position and/or location of the user interface device 11, the region of the environment of the plastic injection-moulding machine 1 is displayed on the screen 12.1 which lies behind the user interface device 11 in the viewing direction of an observer onto the screen 12.1.

Both the cameras 15.1, 15.2, 15.3, the evaluating device 18, and also the user interface device 11 can, as indicated in FIG. 3, respectively optionally be connected in a wired manner or wirelessly to the machine controller 10. The at least one input means 13.1-13.4 of the user interface device 11 is designed, on its manual actuation, to fade out an operating surface 19 of the machine controller 10 displayed on the screen 12.1, and to fade in on the screen 12.1 the region of the environment of the plastic injection-moulding machine 1 lying behind the user interface device 11.

Alternatively or additionally, the user interface device 11 can be connected to the machine controller 10, and the at least one input means 13.1-13.4 or respectively another input means 13.1-13.4 of the user interface device 11 can be designed, on its manual actuation, to simultaneously display on the screen 12.1 in a superimposed presentation an operating surface 19 of the machine controller 10 displayed on the screen 12.1 and the region of the environment of the plastic injection-moulding machine 1 lying behind the user interface device 11, as is indicated in FIG. 3 by the charging hopper 6 of the injection unit 3, presented partially on the screen 12.1.

In particular, the input means 13.4 can, as illustrated in FIG. 2, respectively be a touch input means of the screen 12.1 or the screen 12.1 can have a touch surface designed for the detection of gestures.

### LIST OF REFERENCE NUMBERS

1 plastic injection-moulding machine
2 machine frame
3 injection unit
4 closing unit
5 extruder
6 charging hopper
7 injection-moulding tool
7.1 one mould half
7,2 other mould half
8 closing unit
8.1 fixed platen
8.2 movable platen
9 cavity
10 machine controller
11 user interface device
12 output means
12.1 screen
12.2 screen output means
13.1-13.3 input means
13.4 screen input means
14 housing
14.1 front side
14.2 rear side
15 camera
15.1-15.3 cameras
16 spaces
17 adjusting device
17.1 pivoting device
17.2 mobile stand
18 evaluating device
19 operating surface

What is claimed:

1.-10. (canceled)

11. A plastic injection-moulding machine, comprising:
an injection unit for processing a plastic mass to be moulded;
a closing unit including an injection-moulding tool having a cavity, into which the plastic mass processed by the injection unit is injected to produce a moulded part;
a user interface device including a housing having a front side and a rear side, an input means, and an output means embodying a screen and arranged on the front side of the housing;
a camera arranged on the rear side of the housing and configured to capture a region of the plastic injection-moulding machine lying behind the user interface device; and
a machine controller configured to control operation of the injection unit and the closing unit, said machine controller configured to display on the screen the region captured by the camera.

12. The plastic injection-moulding machine of claim 11, further comprising an adjusting device configured to carry the user interface device and to hold the user interface device in different positions and/or locations, said camera being secured on the rear side of the housing of the user interface device such that the camera assumes a position and/or location in correspondence with a position and/or location of the user interface device, when the adjusting device is adjusted.

13. The plastic injection-moulding machine of claim 12, wherein the camera is rigidly secured on the rear side of the housing of the user interface device.

14. The plastic injection-moulding machine of claim 11, further comprising a supplementary camera arranged at a location of the plastic injection-moulding machine separate from the user interface device, and an evaluating device operably connected to the camera and configured to store image information captured by the camera, to record an instantaneous position and location of the user interface device, to alter the stored image information in accordance with the recorded instantaneous position and location of the user interface device, and to display the stored image information, such that in every position and/or location of the user interface device, the region of an environment of the plastic injection-moulding machine which lies behind the user interface device is displayed on the screen.

15. The plastic injection-moulding machine of claim 11, wherein the user interface device is operably connected to the machine controller, said input means of the user interface device configured to fade out an operating surface of the machine controller displayed on the screen, and to fade in on the screen the region of an environment of the plastic injection-moulding machine lying behind the user interface device, when the input means is manually actuated.

16. The plastic injection-moulding machine of claim 15, wherein the input means is a touch input means of the screen, or the screen has a touch surface designed for detecting gestures.

17. The plastic injection-moulding machine of claim 11, wherein the user interface device is operably connected to the machine controller, said input means of the user interface device configured to display on the screen in a superimposed presentation an operating surface of the machine controller displayed on the screen and the region of an environment of the plastic injection-moulding machine lying behind the user interface device, when the input means is manually actuated.

18. The plastic injection-moulding machine of claim 17, wherein the input means is a touch input means of the screen, or the screen has a touch surface designed for detecting gestures.

19. The plastic injection-moulding machine of claim 11, wherein the user interface device includes a touch input means, which with regard to its position and/or location is designed on the screen such as to be superimposed to a presentation of a machine part of the plastic injection-moulding machine captured by the camera and displayed on the screen.

20. The plastic injection-moulding machine of claim 19, wherein the machine controller is configured to control in a predetermined manner the machine part superimposed by the touch input means, when the touch input means is manually actuated.

21. A plastic injection-moulding machine, comprising:
an injection unit for processing a plastic mass to be moulded;
a closing unit including an injection-moulding tool having a cavity, into which the plastic mass processed by the injection unit is injected to produce a moulded part;
a user interface device including an input means and an output means embodying a screen;
a camera configured to capture a region of the plastic injection-moulding machine lying behind the user interface device, said camera being arranged at a location of the plastic injection-moulding machine separate from the user interface device;
a machine controller configured to control operation of the injection unit and the closing unit, said machine controller configured to display on the screen the region captured by the camera; and
an evaluating device operably connected to the camera and configured to store image information captured by the camera, to record an instantaneous position and location of the user interface device, to alter the stored image information in accordance with the recorded instantaneous position and location of the user interface device, and to display the stored image information, such that in every position and/or location of the user interface device, the region of an environment of the plastic injection-moulding machine which lies behind the user interface device is displayed on the screen.
